(19) United States
(12) Patent Application Publication
(10) Pub. No.: US 2026/0161327 A1
(43) Pub. Date: Jun. 11, 2026

(54) SYSTEM ON CHIP AND MEMORY SYSTEM INCLUDING THE SAME

(71) Applicant: SAMSUNG ELECTRONICS CO., LTD., Suwon-si (KR)

(72) Inventors: Jun Hee YOO, Suwon-si (KR); Gunhee LEE, Suwon-si (KR)

(73) Assignee: SAMSUNG ELECTRONICS CO., LTD., Suwon-si (KR)

(21) Appl. No.: 19/391,510

(22) Filed: Nov. 17, 2025

(30) Foreign Application Priority Data
Dec. 11, 2024 (KR) 10-2024-0183625

(51) Int. Cl. G06F 3/06; G06F 17/16

(52) U.S. Cl. CPC G06F 3/0659; G06F 3/0613; G06F 3/0656; G06F 3/0673; G06F 17/16

(57) ABSTRACT

A system on chip according to the present disclosure includes a processor configured to output a command instructing computing operation, perform its own instruction sequence based on the command, generate an abstract processing command including the computing operation and address information of data related to the computing operation, and output the abstract processing command and data related to the abstract processing command, and a memory controller configured to generate a command/address signal corresponding to the abstract processing command.

### CROSS-REFERENCE TO RELATED APPLICATION

This application claims priority to and the benefit of Korean Patent Application No. 10-2024-0183625 filed with the Korean Intellectual Property Office on Dec. 11, 2024, the entire contents of which are incorporated herein by reference.

### BACKGROUND OF THE INVENTION

Typically, the operating speed of a memory system including a memory device and a host device is bottlenecked by the communication speed between the memory device and the host device. Accordingly, various technologies are being studied to solve bottlenecks caused by communication speed. For example, processing-in-memory (PIM) technology, in which memory devices perform in-memory processing operations, is being studied recently.

The memory device may include an in-memory processor. An in-memory processor may perform predefined computing operations in response to requests from a host device. However, there is a problem that PIM aware programming must be performed for the host device whenever the architecture of the memory device changes or the specification of the in-memory processor changes.

### SUMMARY OF THE INVENTION

The present disclosure seeks to provide a generally usable system-on-chip and a memory system including the same.

A system on chip according to some embodiments may include a processor configured to output a command instructing computing operation, perform its own instruction sequence based on the command, generate an abstract processing command including the computing operation and address information of data related to the computing operation, and output the abstract processing command and data related to the abstract processing command, and a memory controller configured to generate a command/address signal corresponding to the abstract processing command.

A system-on-chip according to some embodiments may include a sequence generator configured to call, based on a computing operation request, an internal function performing a computing operation and generate an abstract processing command using the internal function, wherein the abstract processing command includes the computing operation and address information of data related to the computing operation, a DMA (direct memory access) configured to perform a computing operation among a plurality of computing operations within the abstract processing command and output the abstract processing command, a memory configured to store the data related to the abstract processing command, and a memory controller configured to generate a command/address signal corresponding to the abstract processing command.

A memory system according to some embodiments may include a host device configured to perform its own instruction sequence based on a GEMV (general matrix-vector multiplication) operation request, generate an abstract processing command including a computing operation corresponding to the GEMV and address information of data requested to perform the computing operation, generate a first command/address signal corresponding to the abstract processing command, and generate a second command/address signal corresponding to a memory operation based on a memory operation request, and a memory device configured to perform the computing operation based on the first command/address signal and the memory operation based on the second command/address signal.

### BRIEF DESCRIPTION OF THE DRAWINGS

FIG. 1 is a block diagram of a memory system according to some embodiments.

FIG. 2 is a block diagram of the memory device of FIG. 1.

FIG. 3 is a block diagram of a processor according to some embodiments.

FIG. 4 is a diagram for explaining the GEMV operation.

FIG. 5 is a diagram for explaining high-level commands output by a controller according to some embodiments.

FIG. 6 is a diagram for explaining an abstract processing command according to some embodiments.

FIG. 7 is a diagram for explaining the abstract processing command generated by a sequence generator according to some embodiments.

FIG. 8 is a block diagram of PIMDMA (PIM direct memory access) according to some embodiments.

FIG. 9 is a block diagram of a memory controller according to some embodiments.

FIG. 10 is a block diagram of an exemplary mobile system to which a memory system according to some embodiments of the present disclosure is applied.

FIG. 11 is a block diagram of an exemplary electronic device to which a memory system according to some embodiments of the present disclosure is applied.

FIG. 12 is a block diagram an exemplary computing system to which a memory system according to some embodiments of the present disclosure is applied.

### DETAILED DESCRIPTION OF THE EMBODIMENTS

Hereinafter, embodiments of the present disclosure will be described clearly and in detail to such an extent that a person having ordinary skill in the art of the present disclosure may easily practice the present disclosure. Details such as detailed configurations and structures are provided simply to provide an overall understanding of the embodiments of the present disclosure. Therefore, modifications of the embodiments described herein may be made by those skilled in the art without departing from the technical spirit and scope of the present disclosure. Furthermore, descriptions of well-known functions and structures are omitted for clarity and brevity. The components in the drawings or detailed description below may be connected to other components other than those depicted in the drawings or described in the detailed description. The terms used in the text are terms defined in consideration of the functions of the present disclosure, and are not limited to specific functions. Definitions of terms may be determined based on the matters set forth in the detailed description.

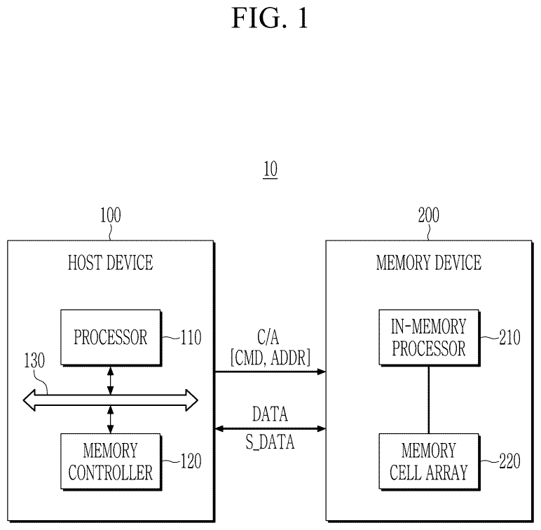

FIG. 1 is a block diagram of a memory system according to some embodiments.

Referring to FIG. 1, a memory system 10 may include a host device 100 and a memory device 200.

In some embodiments, the memory system 10 may be included in various types of electronic devices such as smartphones, laptops, personal computers, tablet PCs, and the like.

In some embodiments, the host device 100 may be implemented as a system on chip. The host device 100 may include a processor 110 and a memory controller 120. The processor 110 and the memory controller 120 may transmit and receive data or signals through the system bus 130. In some embodiments, the system bus 130 may be implemented in a network on a chip NoC. The NoC is a method of connecting processing circuits within a semiconductor chip by applying packet or circuit network technology between general computers or communication devices to a semiconductor chip. The system bus 130 may include router and switching circuits to provide a transmission path for data and signals between processing circuits within the host device 100, that is, the processor 110 and the memory controller 120.

The processor 110 may control the overall operation of the memory system 10. Specifically, the processor 110 is a functional block that performs computing operations within the memory system 10 and may include various processors such as a central processing unit (CPU), a graphics processing unit (GPU), a neural processing unit (NPU), a tensor processing unit (TPU), and a digital signal processor (DSP). The processor 110 may generate instructions to be executed based on an external request and control components (e.g., memory device 200, etc.) within the memory system 10 based on the instructions.

The processor 110 may control the memory controller 120. Specifically, the memory controller 120 may transmit a plurality of command/address signals C/A to the memory device 200 and control the operation of the memory device 200 based on the control of the processor 110. For example, the memory controller 120 may provide data DATA to the memory device 200 or receive data DATA from the memory device 200 based on a plurality of command/address signals C/A.

In some embodiments, the memory controller 120 may generate a command/address signal C/A representing a processing command (hereinafter referred to as “PROC”) based on a command received from the processor 110. The memory controller 120 may transmit a command/address signal C/A indicating a processing command PROC to the memory device 200 and control the operation of the memory device 200. For example, the memory controller 120 may transmit a command/address signal C/A indicating a processing command PROC and data S_DATA required to perform a command indicating the processing command PROC to the memory device 200 so that the in-memory processor 210 within the memory device 200 may perform various computing operations (i.e., in-memory processing operations), and may receive computing results from the memory device 200.

In some embodiments, the memory device 200 may include an in-memory processor 210 and a memory cell array 220. In some embodiments, the memory device 200 may be a DRAM, and the memory controller 120 and the memory device 200 may communicate with each other based on a low power double data rate LPDDR interface. However, the scope of the present disclosure is not limited thereto. For example, the memory controller 120 and the memory device 200 may communicate with each other based on a double data rate DDR interface.

The memory device 200 may operate in response to the control of the memory controller 120. For example, the memory device 200 may store data DATA in the memory cell array 220 or provide data DATA stored in the memory cell array 220 to the memory controller 120 in response to a command CMD and/or an address ADDR corresponding to a command/address signal C/A.

The memory device 200 may operate various computing operations in response to the control of the memory controller 120. For example, the in-memory processor 210 may perform various computing operations based on a command/address signal C/A indicating a processing command PROC provided from a memory controller 120 and data S_DATA required to perform the command indicating the processing command PROC.

In some embodiments, the in-memory processor 210 may perform computing operations based on one or more operands. For example, the in-memory processor 210 may perform various operations such as add, multiplication, multiplication and accumulation MAC, general matrix-matrix multiplication GEMM, and general matrix-vector multiplication GEMV. In this case, even if the host device 100 does not read one or more operands from the memory device 200, the host device 100 may receive the computing result based on one or more operands from the memory device. Therefore, according to the embodiment of the present disclosure, a bottleneck in the operation of the memory system 10 caused by communication between the host device 100 and the memory device 200 may be minimized.

In some embodiments, the memory controller 120 may output a command/address signal C/A representing a processing command PROC based on a command of the processor 110. However, there is a problem that there is no teaching on how the processor 110 will operate the in-memory processor 210 in relation to data operations and PIM aware programming for the processor 110 must be performed when the structure of the memory device 200 (e.g., capacity, number of channels, number of banks, etc.) or the specifications of the in-memory processor 210 are changed.

Accordingly, the present invention seeks to provide a computer architecture that may be universally used even if the structure of a memory device (e.g., capacity, number of channels, number of banks, etc.), specifications of an in-memory processor, and/or applications change.

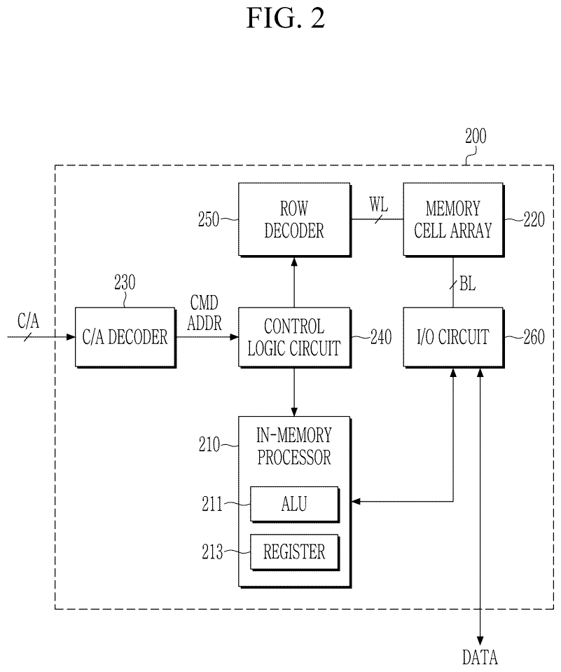

FIG. 2 is a block diagram of the memory device of FIG. 1. Referring to FIG. 2, the memory device 200 may include an in-memory processor 210, a memory cell array 220, a command/address decoder 230, a control logic circuit 240, a row decoder 250, and an input/output circuit 260.

The memory cell array 220 may include a plurality of memory cells arranged in the row direction and the column direction. A plurality of memory cells may be connected to a plurality of word lines WL extending in the row direction and a plurality of bit lines BL extending in the column direction.

The command/address decoder 230 may receive command/address signals C/A from host device 100. The command/address decoder 230 may decode each of a plurality of command/address signals C/A into a command CMD and an address ADDR.

The control logic circuit 240 may receive a command CMD and an address ADDR from the command/address decoder 230. The control logic circuit 240 may control all operations of the memory device 200 based on a command CMD and an address ADDR. For example, the control logic circuit 240 may control the operation of the in-memory processor 220, the row decoder 250, and the input/output circuit 260.

The row decoder 250 may control a plurality of word lines WL based on the control of a control logic circuit 240. For example, the row decoder 250 may activate one of a plurality of word lines WL in response to control of the control logic circuit 240.

The input/output circuit 260 may receive data DATA from the memory controller (120 of FIG. 1) or transmit data DATA to the memory controller 120.

The input/output circuit 260 may be connected to the memory cell array 220 through a plurality of bit lines BL. The input/output circuit 260 may control a plurality of the bit lines BL to read data DATA stored in the memory cell array 220 or store data DATA in the memory cell array 220.

The control logic circuit 240 may control the operation of the in-memory processor 210 based on a command/address signal C/A representing a processing command PROC. The in-memory processor 210 may perform in-memory processing operations in response to control of the control logic circuit 240. For example, the in-memory processor 210 may perform various types of computing operations to generate computing results and store the generated results within the in-memory processor 210.

In some embodiments, the in-memory processor 210 may include an arithmetic logic unit ALU 211 that performs computing operations according to a processing command PROC and a plurality of registers 213 that store intermediate values of the ALU computations or data to be loaded/stored into a memory cell array 220. Additionally, the plurality registers 213 may store computing operations that the in-memory processor 210 may perform. For example, each of one or more operands of a computing operation performed by an in-memory processor 210 may be data stored in a plurality of registers 213 or data provided from a memory cell array 220 through an input/output circuit 260.

In some embodiments, the in-memory processor 210 may perform a computing operation and provide the generated computing result to the memory controller 120 through the input/output circuit 260.

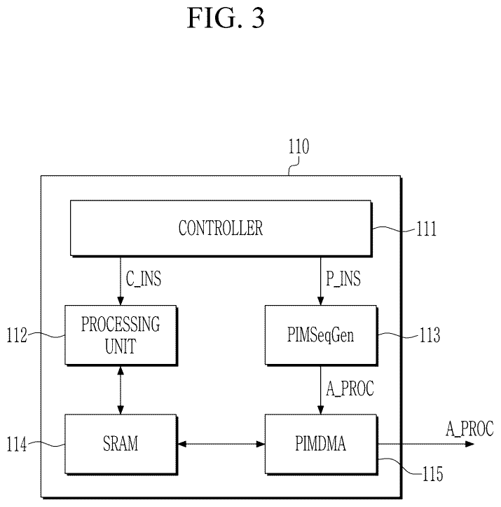

FIG. 3 is a block diagram of a processor according to some embodiments. Specifically, it shows components within a processor 110 within a host device (100 of FIG. 1).

Referring to FIG. 3, the processor 110 may include a controller 111, a processing unit 112, a sequence generator (PIMSeqGen; 113), SRAM 114, and PIMDMA 115.

In some embodiments, the controller 111 may control operations of the processing unit 112 and the sequence generator 113. Specifically, the controller 111 may output a command C_INS for controlling the processing unit 112, and the processing unit 112 may perform various operations for controlling the memory system (10 of FIG. 1) based on the command C_INS.

In some embodiments, the controller 111 may output a command P_INS to control the computing operation of the in-memory processor (210 of FIG. 1) based on an external request.

The controller 111 may output a command P_INS for controlling the operation of the in-memory processor 210 to the sequence generator 113. Here, the command P_INS may include the computing operation and address information of data required for the operation. The command P_INS output by the controller 111 is a high-level instruction, and the sequence generator 113 may perform its own instruction sequence based on the command P_INS. Here, the own instruction sequence may mean calling an internal function based on a command P_INS and generating the abstract processing command A_PROC corresponding to each computing operation based on the internal function. The own instruction sequence may comprise at least one command to call an internal function based on a command P_INS and generate the abstract processing command A_PROC corresponding to each computing operation based on the internal function.

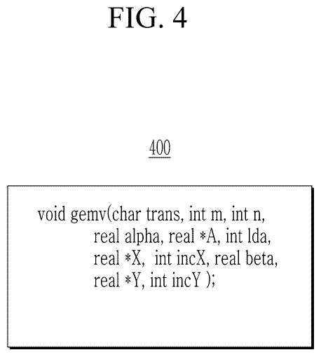

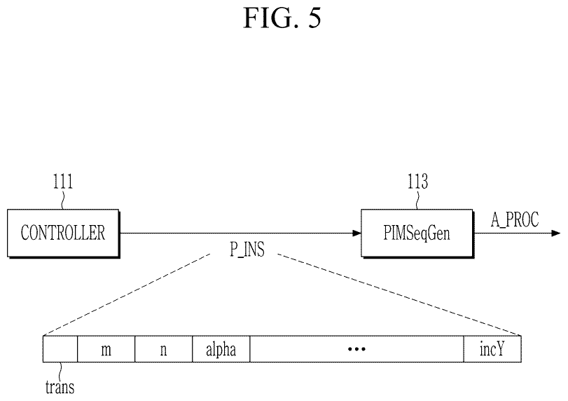

A specific description of the command P_INS output by the controller 111 will be described later with reference to FIG. 4 and FIG. 5.

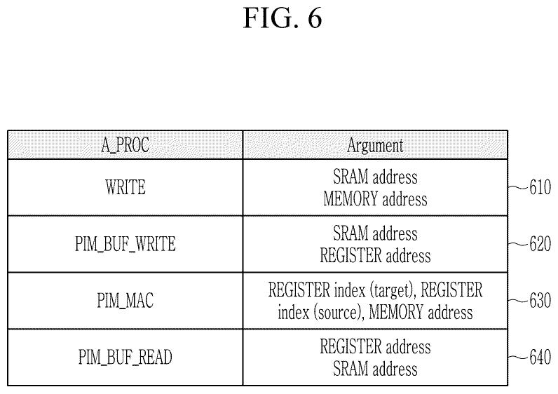

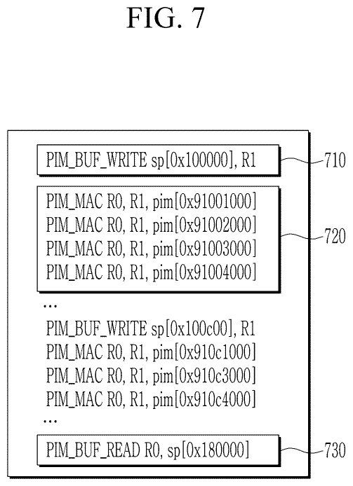

In some embodiments, the sequence generator 113 may execute its own instruction sequence based on the command P_INS and output a series of abstract processing commands A_PROC. Here, the abstract processing command A_PROC may include the computing operation, address information where data required for the computing operation is stored, and/or address information where computing operation result data is stored. Meanwhile, the address information in the abstract processing command A_PROC may be the virtual address independent of the structure of the actual memory device (200 of FIG. 1). Therefore, the sequence generator 113 does not need to recognize specific specifications of the memory device 200, such as the structure of the physically connected memory device 200. A specific description of the abstract processing command A_PROC generated by the sequence generator 113 is described later with reference to FIG. 6 and FIG. 7.

In some embodiments, the sequence generator 113 may exist as independent hardware from the controller 111 or processing unit 112. When the sequence generator 113 exists integrated with a controller 111 or a processing unit 112, the operation of the processor 110 or the processing unit 112 and the operation of the sequence generator 113 may not be performed in parallel, and overhead may occur, such as the addition of a switching operation to perform them simultaneously. In an exemplary embodiment, the sequence generator 113 may be implemented as, but is not limited to, a microprocessor implemented as a standalone hardware or any device capable of executing and responding to instructions.

In some embodiments, PIMDMA 115 may receive an abstract processing command A_PROC from the sequence generator 113 and output the abstract processing command A_PROC to the memory controller 120 via the system bus (130 of FIG. 1). In some embodiments, PIMDMA 115 may transfer data to be stored in the memory device 200 from SRAM 114 to the memory controller 120, or transfer data received from the memory controller 120 to SRAM 114, based on an abstract processing command A_PROC.

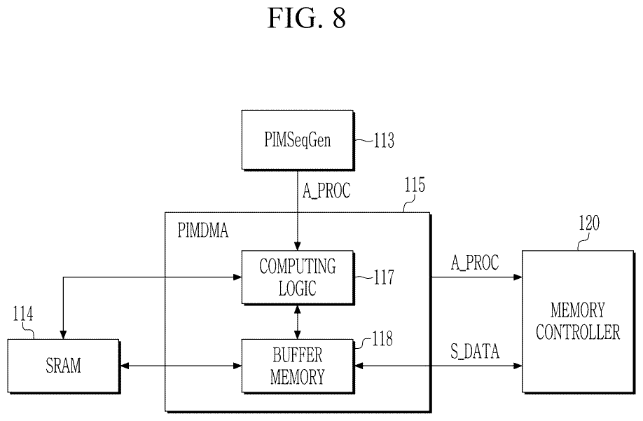

In some embodiments, PIMDMA 115 may perform the predetermined computing operations. PIMDMA 115 may perform the computing operations corresponding to a specific layer among a plurality of layers corresponding to the plurality of computing operations included in an abstract processing command A_PROC. For example, a predetermined computing operation may be performed on data received from a memory controller 120 and the data is generated as the computing results of computing operations corresponding to an abstract processing command A_PROC. Here, the computing operation for a specific layer may include, but is not limited to, Rectified Linear Unit ReLU or batch normalization. A detailed description of the structure and operation method of PIMDMA 115 is described later with reference to FIG. 8.

In some embodiments, the processor 110 may include SRAM 114. The SRAM 114 may store the information generated in process of the operations of the processor 110 or store the information requested to process the operations of the processor 110. For example, the controller 111 may store data required for an operation performed based on an abstract processing command A_PROC in SRAM 114, or store data generated as a result of the abstract processing command A_PROC in SRAM 114. However, it is not limited thereto, and the controller 111 may store various data necessary for controlling the processing unit 112 in the SRAM 114.

Below, the operation method of each component of the processor 110 is described in detail. Specifically, an operation is described in which a controller 111 outputs the command P_INS instructing the in-memory processor 210 to perform the GEMV operation, and the sequence generator 113 outputs the abstract processing command A_PROC corresponding to the command P_INS. However, it is not limited thereto, the processor 110 may generate and output a command P_INS that instructs the in-memory processor 210 to perform various computing operations and the corresponding abstract processing command A_PROC.

FIG. 4 is a diagram for explaining the GEMV operation, and FIG. 5 is a diagram for explaining high-level commands output by a controller according to some embodiments.

GEMV operation refers to a linear algebra operation that performs the multiplication of matrix and vector. Specifically, the GEMV operation is an operation that multiplies matrix A and vector X and stores the result in vector Y, and the GEMV operation is as shown in Equation 1.

$$\vec{Y} = α \times A \times \vec{X} + β \times \vec{Y} \qquad ( Equation 1 )$$

Referring to FIG. 3 and FIG. 4, the GEMV function is one of the functions provided in the BLAS (Basic Linear Algebra Subprograms) library, and the controller 111 may output data necessary for the sequence generator 113 to call the internal function corresponding to the GEMV function and generate the abstract processing command A_PROC corresponding to the GEMV operation, based on a function call API (function call application processing interface; 400) that calls a predefined internal function corresponding to the GEMV function.

That is, by calling the GEMV function or the internal function corresponding to the GEMV function at a higher level, such as the controller 111 or the sequence generator 113, and implementing the GEMV operation to be performed in the in-memory processor (210 of FIG. 1), the versatility (or compatibility) of the processor 110 may be improved.

In some embodiments, the controller 111 may output structured data including information about parameters within the function call API 400 as the command P_INS to provide the sequence generator 113 with information necessary to call the internal function corresponding to the GEMV operation and generate the abstract processing command A_PROC. Looking at each parameter, “trans” determines whether matrix A is transposed, and “m” and “n” represent the rows and columns of matrix A, respectively. “Alpha(α)” is a scalar constant that is multiplied by matrix A and vector X, and “*A” represents a pointer to matrix A.

“Ida” represents the leading dimension of matrix A, “*X” represents a pointer to vector X, and “beta(β)” is a scalar constant that is multiplied by vector Y. “*” is a pointer where vector Y will be stored as a result of the computing operation, and “incX” and “incY” represent the stride between elements in vector X and vector Y, respectively. That is, the GEMV operation may be the operation that multiplies an m×n-sized matrix A, an n-dimensional vector X, and a constant alpha (α), multiplies an existing m-dimensional vector Y by a constant beta (β), and then adds the two results to obtain a new vector Y.

Referring to FIG. 5, information about each input parameter may include at least one bit. In some embodiments, the controller 111 may output structured data containing information about parameters to the sequence generator 113 as the command P_INS. The command P_INS may include information required for the internal function call performed by the sequence generator 113 to generate the abstract processing command A_PROC. That is, the sequence generator 113 may call the internal function for generating the abstract processing command A_PROC corresponding to the GEMV operation based on the data included in the command P_INS.

In some embodiments, the sequence generator 113 may perform its own instruction sequence based on the command P_INS. Here, the own instruction sequence may include calling the internal function corresponding to the GEMV function based on the command P_INS and outputting the abstract processing command A_PROC corresponding to the GEMV operation. That is, the sequence generator 113 may perform its own instruction sequence based on the command P_INS and output abstract processing commands A_PROC for computing operations to be performed in the in-memory processor (210 of FIG. 1).

FIG. 6 is a diagram for explaining an abstract processing command according to some embodiments.

In some embodiments, the sequence generator 113 may output various abstract processing commands A_PROC according to commands from the controller 111. An abstract processing command A_PROC may contain a plurality of operators and operands.

Looking at each command in detail, the abstract processing command 610 may be the command that instructs to read data stored in the SRAM (114 of FIG. 3) within the processor (110 of FIG. 3) and store the data in the memory cell array (220 of FIG. 2) within the memory device (200 of FIG. 2).

The abstract processing command 620 may be the command that instructs to read data stored in the SRAM 114 within the processor 110 and store the data in the register 213 within the in-memory processor 210. The abstract processing command 630 may be the command that instructs the in-memory processor 210 to perform the MAC operation. The abstract processing command 640 may be the command that instructs to read data stored in the register 213 and store the data in SRAM 114. However, the abstract processing commands described here are exemplary, and the sequence generator 113 may support more abstract processing commands A_PROC. Additionally, abstract processing commands A_PROC may be generated in various forms.

As described above, the abstract processing command A_PROC may include the computing operation, address information where data required for the computing operation is stored, and/or address information where computing result data is to be stored. At this time, the address information in the abstract processing command A_PROC may be the virtual address independent of the structure of the actual memory device 200. The abstract processing command A_PROC according to some embodiments may be generated in a form independent of the structure of the memory device 200 or the specifications of the in-memory processor 210.

FIG. 7 is a diagram for explaining the abstract processing command generated by a sequence generator according to some embodiments. Specifically, it represents an abstract processing command generated by a sequence generator 113 based on a command P_INS that instructs to perform a GEMV operation received from a controller 111.

As described above with respect to FIG. 5, the sequence generator 113 may perform its own instruction sequence based on the command P_INS received from the controller 111. Specifically, the sequence generator 113 may call the predetermined internal function based on the command P_INS received from the controller 111 and output the abstract processing command A_PROC.

In some embodiments, the sequence generator 113 may output the abstract processing command A_PROC via the internal function call for the GEMV operation. Specifically, the sequence generator 113 may output the abstract processing command A_PROC that instructs a GEMV computing operation based on the command P_INS. The abstract processing command A_PROC that instructs the GEMV computing operation may include the command that instructs to read input data required for the GEMV computing operation, perform the computing operation based on the input data, and output result data.

Referring to FIG. 7, the first abstract processing command 710 may instruct to read data stored at “0x100000” of the SRAM 114 within the processor 110 and store the data in an “R1” register among a plurality of registers 213 within an in-memory processor 210. The second abstract processing command 720 may instruct the MAC operation on data stored in the “R0” and “R1” registers among the plurality of registers 213 in the in-memory processor 210 and the “0x91001000 address” in the memory cell array 220. An operation like Equation 2 is performed according to the second abstract processing command 720, and the computing result may be stored in the “R0” register.

$$R 0 = R 0 + R 1 * PIM [ address ] \qquad ( Equation 2 )$$

The third abstract processing command 730 may instruct to read data stored in the “R0” register among the plurality of registers 213 within the in-memory processor 210 and store the data in the “0x180000” address of the SRAM 114 within the processor 110. In this manner, the sequence generator 113 may output the abstract processing command A_PROC that instructs the GEMV operation.

FIG. 8 is a block diagram of PIMDMA according to some embodiments.

In some embodiments, PIMDMA 115 may include computing logic 117 and buffer memory 118. Although not shown here, in some embodiments, PIMDMA 115 may further include a decoder for decoding the abstract processing command A_PROC.

In some embodiments, PIMDMA 115 may control data movement between SRAM 114 and memory controller 120 and perform the predetermined computing operation, based on the abstract processing command A_PROC received from sequence generator 113.

In some embodiments, the computing logic 117 may perform the predetermined computing operation for the abstract processing command A_PROC. Specifically, the abstract processing command A_PROC includes the plurality of computing operations, and each computing operation may correspond to a layer. In some embodiments, the computing logic 117 may receive result data of the computing operation performed according to the abstract processing command A_PROC from the memory controller 120 and transmit it to the SRAM 114. At this time, the computing logic 117 may perform the computing operation corresponding to a specific layer on the result data before transferring the result data to the SRAM 114. Here, a specific layer may be the layer corresponding to the next computing operation on the result data. Alternatively, the computing logic 117 may transfer input data from the SRAM 114 to the memory controller 120 to perform the computing operation according to the abstract processing command A_PROC. At this time, the computing logic 117 may perform the computing operation corresponding to a specific layer for the input data before transmitting the input data to the memory controller 120. Here, a specific layer may be a layer corresponding to the computing operation before input data is transferred from SRAM 114 to the memory controller 120.

In some embodiments, the layer corresponding to the computing operation performed by the computing logic 117 may be predetermined. Specifically, the layer corresponding to the computing operation performed by the computing logic 117 may be a layer in which the sizes of input data and output data are the same, each component of the input data is one-to-one matched with a component of the output data, and there is no dependency other than the one-to-one matched data. For example, it may include, but is not limited to, layers corresponding to one of ReLU, batch normalization, scatter/gather of data, and transpose operations. In some embodiments, computing operations corresponding to the specific layer may be performed on-the-fly during the process of transferring from the memory controller 120 to the SRAM 114. In an exemplary embodiment, the computing logic 117 may be implemented as a microprocessor, but is not limited thereto.

In some embodiments, the buffer memory 118 may store the abstract processing command A_PROC and data received from the sequence generator 113. Specifically, the buffer memory 118 may temporarily store data stored in the SRAM 114 to output the data to the memory controller 120 or to transfer the data received from the memory controller 120 to the SRAM 114. Alternatively, data based on the results of the computing operation performed in the computing logic 117 may be temporarily stored. The buffer memory 118 may output the abstract processing command A_PROC received from the sequence generator 113 and data S_DATA required to perform the computing operation according to the abstract processing command A_PROC r to the memory controller 120. Here, data S_DATA required to perform the computing according to the abstract processing command A_PROC may include, but is not limited to, data stored in SRAM 114 or data according to the computing result performed in the computing logic 117.

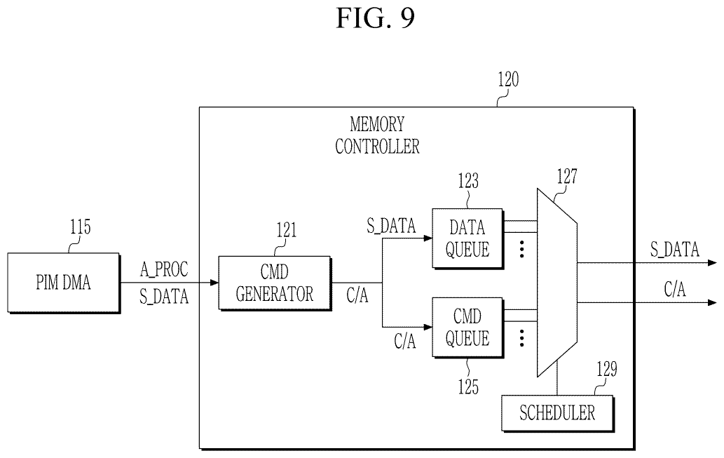

FIG. 9 is a block diagram of a memory controller according to some embodiments.

In some embodiments, the memory controller 120 may include a command generator 121, a data queue 123, a command queue 125, a multiplexer 127, and a scheduler 129.

Referring to FIG. 9, the memory controller 120 may receive the abstract processing command A_PROC corresponding to the computing operation from PIMDMA 115. The abstract processing command A_PROC may include address information for the computing operation and data required for the computing operation. The memory controller 120 may receive data S_DATA required for the computing operation along with the abstract processing command A_PROC. The data S_DATA required for the computing operation may be data stored in PIMDMA 115 or data for which a predetermined computing operation has been performed by PIMDMA 115.

In some embodiments, the command generator 121 may convert the abstract processing command A_PROC into a command/address signal C/A representing the processing command PROC. Specifically, the command generator 121 may change the virtual address information in the abstract processing command A_PROC to the physical address of the memory device 200. Additionally, the command generator 121 may convert the abstract processing command A_PROC into a command/address signal C/A representing a processing command PROC so that the in-memory processor 210 can perform various computing operations (i.e., in-memory processing operations).

In some embodiments, the data S_DATA required to perform a command indicating a processing command PROC may be queued in a data queue 123, and a command/address signal C/A indicating the processing command PROC may be queued in a command queue 125.

The scheduler 129 may schedule the operation order of the command/address signal C/A according to the priority of the command/address signal C/A queued in the command queue 125, and the multiplexer 127 may output data S_DATA and the command/address signal C/A to the memory device 200.

Meanwhile, although the memory controller 120 is depicted here as processing command/address signals C/A and data S_DATA related to the computing operation of the in-memory processor, it is not limited thereto. For example, the memory controller 120 may process requests for memory operations (e.g., read, write, and erase operations) for the memory device 200 and computing operations for the in-memory processor 210 together. That is, data S_DATA required to perform a command indicating a processing command PROC and data DATA related to a memory operation may be queued together in a data queue 123, and a command/address signal C/A corresponding to the processing command PROC and a command/address signal C/A corresponding to the memory operation may be queued together in a command queue 125. At this time, the scheduler 129 may schedule the operation order of the command/address signal C/A queued in the command queue 125 according to the priority of the commands, and the multiplexer 127 may output data S_DATA or DATA and the command/address signal C/A to the memory device 200.

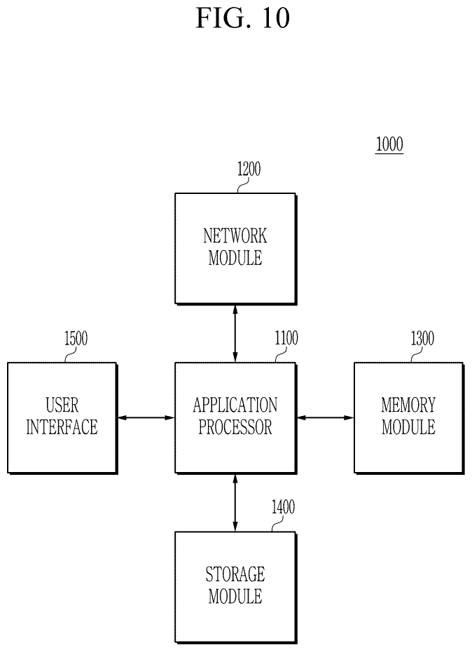

FIG. 10 is a block diagram of an exemplary mobile system to which a memory system according to some embodiments of the present disclosure is applied.

Referring to FIG. 10, the mobile system 1000 may include an application processor 1100, a network module 1200, a memory module 1300, a storage module 1400, and a user interface 1500. The application processor 1100 may correspond to the host device (100 of FIG. 1) and the detailed description for the application processor 1100 may be replaced by the descriptions of FIG. 1. Specifically, the application processor 1100 according to some embodiments may perform its own instruction sequence based on an external operation request and generate the abstract processing instruction based on its own instruction sequence. The abstract processing command according to some embodiments may be the command independent of the structure of the memory module 1300 or the specifications of the memory module 1300. The application processor 1100 according to some embodiments may generate the command/address signal corresponding to the abstract processing instruction and output the command/address signal to the memory module 1300.

The network module 1200 may communicate with the external devices. For example, the network module 1200 may support wireless communications such as CDMA (Code Division Multiple Access), GSM (Global System for Mobile communication), WCDMA (wideband CDMA), CDMA-2000, TDMA (Time Division Multiple Access), LTE (Long Term Evolution), Wimax, WLAN, UWB, Bluetooth, WI-DI, etc.

The memory module 1300 may operate as a main memory, operating memory, buffer memory, or cache memory of the mobile system 1000. The memory module 1300 may include volatile random access memory such as DRAM, SDRAM, DDR SDRAM, DDR2 SDRAM, DDR3 SDRAM, LPDDR SDARM, LPDDR3, SDRAM, LPDDR3 SDRAM, etc., or nonvolatile random access memory such as PRAM, ReRAM, MRAM, FRAM, etc.

The storage module 1400 may store data. For example, the storage module 1400 may store data received from outside. The storage module 1400 may transmit data stored in the storage module 1400 to the application processor 1100. For example, the storage module 1400 may be implemented with a nonvolatile semiconductor memory device such as PRAM, MRAM, RRAM, NAND flash, NOR flash, or a three-dimensional structured NAND flash. For example, the storage module 1400 may be provided as a solid state drive SSD, a multimedia card MMC, an embedded multimedia card eMMC, a universal flash storage UFS, etc.

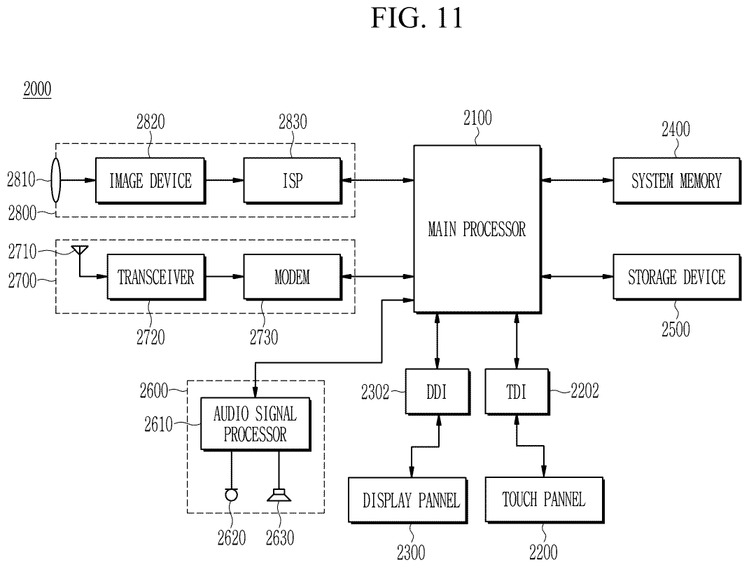

FIG. 11 is a block diagram of an exemplary electronic device to which a memory system according to some embodiments of the present disclosure is applied.

Referring to FIG. 11, the electronic device 2000 may include a main processor 2100, a touch panel 2200, a touch driving circuit TDI 2202, a display panel 2300, a display driving circuit DDI 2302, a system memory 2400, a storage device 2500, an audio processor 2600, a communication block 2700, and an image processor 2800. In some embodiments, the electronic device 2000 may be one of various electronic devices, such as a mobile communication terminal, a Personal Digital Assistant (PDA), a Portable Media Player (PMP), a digital camera, a smart phone, a tablet computer, a laptop computer, a wearable device, and the like.

The main processor 2100 may control the overall operations of the electronic device 2000. The main processor 2100 may control/manage the operations of components of the electronic device 2000. The main processor 2100 may process various computing operations to operate the electronic device 2000. The touch panel 2200 may be configured to detect touch input from a user under the control of a touch driving circuit 2202. The display panel 2300 may be configured to display image information under the control of the display driving circuit 2302. In some embodiments, the main processor 2100 may correspond to the processor (110 of FIG. 1).

The system memory 2400 may store data used for the operation of the electronic device 2000. For example, the system memory 2400 may include volatile memory such as SRAM, DRAM, SDRAM, and/or nonvolatile memory such as PRAM, MRAM, ReRAM, FRAM, and the like. The storage device 2500 may store data regardless of power supply. For example, the storage device 2500 may include at least one of various non-volatile memories such as flash memory, PRAM, MRAM, ReRAM, FRAM, etc. For example, the storage device 2500 may include built-in memory and/or removable memory of the electronic device 2000.

The audio processor 2600 may process an audio signal using an audio signal processor 2610. The audio processor 2600 may receive audio input through a microphone 2620 or provide audio output through a speaker 2630. The communication block 2700 may exchange signals with an external device/system through an antenna 2710. The transceiver 2720 and modem 2730 of the communication block 2700 may process signals exchanged with an external device/system according to at least one of various wireless communication protocols, such as LTE (Long Term Evolution), WiMax (Worldwide Interoperability for Microwave Access), GSM (Global System for Mobile communication), CDMA (Code Division Multiple Access), Bluetooth, NFC (Near Field Communication), Wi-Fi (Wireless Fidelity), RFID (Radio Frequency Identification), etc. The image processor 2800 may receive light through the lens 2810. An image device 2820 and an image signal processor ISP 2830 included in the image processor 2800 may generate image information about an external object based on the received light.

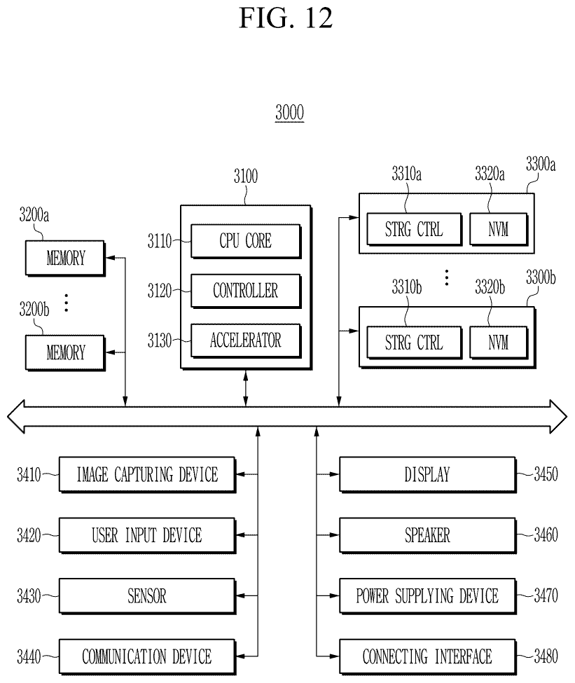

FIG. 12 is a block diagram an exemplary computing system to which a memory system according to some embodiments of the present disclosure is applied.

Referring to FIG. 12, the computing system 3000 may be a mobile system, such as a mobile phone, a smart phone, a tablet personal computer, a wearable device, a healthcare device, or an Internet of Things (IoT) device. However, the embodiment is not necessarily limited thereto, and the computing system 3000 of FIG. 12 may be a personal computer, a laptop computer, a server, a media player, or an automotive device such as a navigation device.

The computing system 3000 may include a main processor 3100, a memory 3200a, 3200b, and a storage device 3300a, 3300b, and may additionally include one or more of a photographing device IMAGE CAPTURING DEVICE 3410, a user input device 3420, a sensor 3430, a communication device 3440, a display 3450, a speaker 3460, a power supplying device 3470, and a connecting interface 3480.

The main processor 3100 may control the overall operation of the computing system 3000, more specifically, the operation of other components that make up the computing system 3000. Such a main processor 3100 may be implemented as a general-purpose processor, a dedicated processor, or an application processor.

The main processor 3100 may include one or more CPU cores 3110 and may further include a controller 3120 for controlling memory 3200a, 3200b and/or storage devices 3300a, 3300b. In some embodiments, the main processor 3100 may further include an accelerator 3130, which is a dedicated circuit for high-speed data operations such as AI (Artificial Intelligence) data operations. Such an accelerator 3130 may include a GPU (Graphics Processing Unit), an NPU (Neural Processing Unit), and/or a DPU (Data Processing Unit), and may be implemented as a separate chip that is physically independent from other components of the main processor 3100. In some embodiments, the main processor 3100 may correspond to the processor (110 of FIG. 1).

The memory 3200a, 3200b may be used as a main memory device of the computing system 3000 and may include volatile memory such as SRAM and/or DRAM, but may also include non-volatile memory such as flash memory, MRAM, PRAM, and/or RRAM. The memory 3200a, 3200b may also be implemented within the same package as the main processor 3100.

The storage device 3300a, 3300b may function as a non-volatile storage device that stores data regardless of whether power is supplied, and may have a relatively large storage capacity compared to the memory 3200a, 3200b. A storage device 3300a, 3300b may include a storage controller 3310a, 3310b and a nonvolatile memory 3320a, 3320b that stores data under the control of the storage controller 3310a, 3310b. The nonvolatile memory 3320a, 3320b may include flash memory of a 2D (2-dimensional) structure or a 3D (3-dimensional) V-NAND (Vertical NAND) structure, but may also include other types of nonvolatile memory such as MRAM, PRAM, and/or RRAM.

The storage device 3300a, 3300b may be included in the computing system 3000 physically separated from the main processor 3100, or may be implemented within the same package as the main processor 3100. In addition, the storage device 3300a, 3300b may have a form such as a solid state drive (SSD) or a memory card, and may be detachably connected to other components of the computing system 3000 through an interface such as a connection interface 3480 to be described later. Such storage devices 3300a, 3300b may be devices to which standard specifications such as UFS (Universal Flash Storage), eMMC (embedded multi-media card) or NVMe (non-volatile memory express) are applied, but are not necessarily limited thereto.

The photographing device 3410 may capture still or moving images and may be a camera, a camcorder, and/or a webcam.

The user input device 3420 may receive various types of data input from a user of the computing system 3000, and may be a touch pad, a keypad, a keyboard, a mouse, and/or a microphone.

The sensor 3430 may detect various types of physical quantities that may be obtained from outside the computing system 3000 and convert the detected physical quantities into electrical signals. Such sensors 3430 may be temperature sensors, pressure sensors, light sensors, position sensors, acceleration sensors, biosensors, and/or gyroscope sensors.

The communication device 3440 may transmit and receive signals between other devices outside the computing system 3000 according to various communication protocols. Such a communication device 3440 may be implemented including an antenna, a transceiver, and/or a modem.

The display 3450 and speaker 3460 may function as output devices that output visual information and auditory information, respectively, to a user of the computing system 3000.

The power supplying device 3470 may appropriately convert power supplied from a battery (not shown) built into the computing system 3000 and/or an external power source and supply it to each component of the computing system 3000.

The connection interface 3480 may provide a connection between the computing system 3000 and an external device that is connected to the computing system 3000 and may exchange data with the computing system 3000. The connection interface 3480 may be implemented in various interface methods such as ATA (Advanced Technology Attachment), SATA (Serial ATA), e-SATA (external SATA), SCSI (Small Computer Small Interface), SAS (Serial Attached SCSI), PCI (Peripheral Component Interconnection), PCIe (PCI express), NVMe, IEEE 1394, USB (universal serial bus), SD (secure digital) card, MMC (multi-media card), eMMC, UFS, eUFS (embedded Universal Flash Storage), CF (compact flash) card interface, etc.

Although the embodiments of the present invention have been described in detail above, the scope of the present invention is not limited thereto, and various modifications and improvements made by those skilled in the art using the basic concept of the present invention defined in the following claims also fall within the scope of the present invention.

What is claimed is:

1. A system on chip, comprising:
a processor configured to output a command instructing computing operation, perform its own instruction sequence based on the command, generate an abstract processing command including the computing operation and address information of data related to the computing operation, and output the abstract processing command and data related to the abstract processing command; and
a memory controller configured to generate a command/address signal corresponding to the abstract processing command.

2. The system on chip of claim 1, wherein the processor comprises:
a controller configured to generate the command based on an external request;
a sequence generator configured to generate the abstract processing command;
a memory configured to store the data related to the abstract processing command; and
a DMA (direct memory access) configured to output the abstract processing command and the data related to the abstract processing command.

3. The system on chip of claim 1, wherein the command includes structured data including information about the own instruction sequence.

4. The system on chip of claim 3, wherein the own instruction sequence comprises a command to call an internal function corresponding the computing operation and to generate the abstract processing command based on the internal function.

5. The system on chip of claim 1, wherein the abstract processing command comprises one or more of the computing operation corresponding to the command, the address information of data related to the computing operation, and address information of data that is generated as computing results of the computing operation.

6. The system on chip of claim 2, wherein the DMA comprises:
a computing logic configured to perform the computing operation for the data related to the abstract processing command and the data generated as computing results; and
a buffer memory configured to store the data related to the abstract processing command and the data generated as the computing results.

7. The system on chip of claim 6, wherein the computing operation comprises ReLU (Rectified Linear Unit), batch normalization, scatter/gather of data, and transpose.

8. The system on chip of claim 6, wherein the computing logic is implemented as a microprocessor.

9. The system on chip of claim 1, wherein the memory controller comprises:
a command generator configured to generate the command/address signal based on the abstract processing command; and
a scheduler configured to instruct to output the command/address signal and the data related to the abstract processing command based on priority of a plurality of command/address signals queued in command queue.

10. The system on chip of claim 1, wherein the computing operation includes GEMV (general matrix-vector multiplication).

11. A system on chip, comprising:
a sequence generator configured to call, based on a computing operation request, an internal function performing a computing operation and generate an abstract processing command using the internal function, wherein the abstract processing command includes the computing operation and address information of data related to the computing operation;
a DMA (direct memory access) configured to perform a computing operation among a plurality of computing operations within the abstract processing command and output the abstract processing command;
a memory configured to store the data related to the abstract processing command; and
a memory controller configured to generate a command/address signal corresponding to the abstract processing command.

12. The system on chip of claim 11, wherein the computing operation request includes structured data including information for a parameter within API (application processing interface), wherein the API calls the internal function corresponding to GEMV (general matrix-vector multiplication).

13. The system on chip of claim 12, wherein the sequence generator is configured to generate the abstract processing command using the internal function, wherein the abstract processing command includes a plurality of computing operations corresponding to the GEMV.

14. The system on chip of claim 13, wherein the abstract processing command comprises:
a first command instructing to output data stored in the memory and requested to perform the plurality of the computing operations;
a second command instructing to perform the plurality of the computing operations; and
a third command instructing to store data generated as computing results of the plurality of the computing operations in the memory.

15. The system on chip of claim 14, wherein the DMA comprises:
a computing logic configured to perform a computing operation for the data generated as the computing results; and
a buffer memory configured to store the output data and the data generated as the computing results.

16. The system on chip of claim 15, wherein the computing operation comprises ReLU (Rectified Linear Unit), batch normalization, scatter/gather of data, and transpose.

17. A memory system, comprising:
a host device configured to perform its own instruction sequence based on a GEMV (general matrix-vector multiplication) operation request, generate an abstract processing command including a computing operation corresponding to the GEMV and address information of data requested to perform the computing operation, generate a first command/address signal corresponding to the abstract processing command, and generate a second command/address signal corresponding to a memory operation based on a memory operation request; and
a memory device configured to perform the computing operation based on the first command/address signal and the memory operation based on the second command/address signal.

18. The memory system of claim 17, wherein the host device comprises:
a controller configured to output structured data including information for the own instruction sequence as the GEMV operation request;
a sequence generator configured to call an internal function corresponding to the GEMV and generate the abstract processing command based on the internal function;
a DMA (direct memory access) configured to output the abstract processing command and data related to the abstract processing command; and
a memory controller configured to generate the first command/address signal and the second command/address signal, and output the first command/address signal and the second command/address signal to the memory device based on a priority of commands.

19. The memory system of claim 18, wherein the DMA is implemented as a microprocessor configured to perform a predetermined computing operation among a plurality of computing operations within the abstract processing command.

20. The memory system of claim 17, wherein the memory device comprises:
an in-memory processor configured to perform the computing operation; and
a memory cell array configured to perform the memory operation.
